(19) United States
(12) Patent Application Publication
(10) Pub. No.: US 2024/0163910 A1
(43) Pub. Date: May 16, 2024

(54) LATENCY TRIGGERED SIDELINK RESOURCE RESELECTION

(71) Applicant: QUALCOMM Incorporated, San Diego, CA (US)

(72) Inventors: Guibing GU, Shanghai (CN); Jintao HOU, Beijing (CN); Cheol Hee PARK, San Diego, CA (US); Hongjin GUO, Beijing (CN); Abha KHOSLA, San Diego, CA (US)

(21) Appl. No.: 18/548,430

(22) PCT Filed: Apr. 14, 2021
(86) PCT No.: PCT/CN2021/087150

§ 371 Date: Aug. 30, 2023

(51) Int. Cl. H04W 72/40; H04L 5/00; H04W 72/54

(52) U.S. Cl. CPC H04W 72/40; H04L 5/0078; H04W 72/54

(57) ABSTRACT

Certain aspects of the present disclosure provide techniques for sidelink communications. A method that may be performed by a user equipment (UE) includes monitoring a latency between a packet arrival time from an upper layer at the UE and an over-the-air (OTA) packet transmission time. The latency is based at least in part on, a first number of subframes reserved for a sidelink synchronization signal (SLSS) and/or a second number of subframes reserved based on a configured subframe bitmap. The method includes triggering a transmit resource selection at the UE when the latency exceeds a threshold latency.

### INTRODUCTION

Aspects of the present disclosure relate to wireless communications, and more particularly, to techniques for sidelink resource reselection for wireless communication between devices.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. After considering this discussion, and particularly after reading the section entitled “Detailed Description” one will understand how the features of this disclosure provide advantages that include latency based sidelink resource selection.

Certain aspects relate to an apparatus for wireless communication. In some examples, the apparatus includes at least one processor and a memory coupled to the at least one processor. In some examples, the memory includes code executable by the at least one processor to cause the apparatus to monitor a latency between a packet arrival time from an upper layer at the apparatus and an over-the-air (OTA) packet transmission time. The latency is based at least in part on, a first number of subframes reserved for a sidelink synchronization signal (SLSS), a second number of subframes reserved based on a configured subframe bitmap, or a combination thereof. The memory includes code executable by the at least one processor to cause the apparatus to trigger a transmit resource selection at the apparatus when the latency exceeds a threshold latency.

Certain aspects relate to a method for wireless communication that may be performed by a user equipment (UE). In some examples, the method includes monitoring a latency between a packet arrival time from an upper layer at the UE and OTA packet transmission time. The latency is based at least in part on, a first number of subframes reserved for a SLSS, a second number of subframes reserved based on a configured subframe bitmap, or a combination thereof. The method includes triggering a transmit resource selection at the UE when the latency exceeds a threshold latency.

Certain aspects relate to an apparatus for wireless communication. In some examples, the apparatus includes means for monitoring a latency between a packet arrival time from an upper layer at the UE and OTA packet transmission time. The latency is based at least in part on, a first number of subframes reserved for a SLSS, a second number of subframes reserved based on a configured subframe bitmap, or a combination thereof. The apparatus includes means for triggering a transmit resource selection at the apparatus when the latency exceeds a threshold latency.

Certain aspects relate to a computer-readable medium storing computer executable code therein for wireless communications by a UE. In some examples, the computer executable code includes code for monitoring a latency between a packet arrival time from an upper layer at the UE and an OTA packet transmission time. The latency is based at least in part on, a first number of subframes reserved for a SLSS, a second number of subframes reserved based on a configured subframe bitmap, or a combination thereof. The computer executable code includes code for triggering a transmit resource selection at the UE when the latency exceeds a threshold latency.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and the description may admit to other equally effective aspects.

FIG. 1 is a block diagram conceptually illustrating an example telecommunications system, in accordance with certain aspects of the present disclosure.

FIG. 2 is a block diagram conceptually illustrating a design of two example user equipment (UEs), in accordance with certain aspects of the present disclosure.

FIG. 3 is a diagram conceptually illustrating an example of a first UE communicating with one or more other UEs according to aspects of the present disclosure.

FIG. 4 is a diagram illustrating an example frame format, in accordance with certain aspects of the present disclosure.

FIG. 5 is a schematic diagram illustrating an example model of multiple wireless devices operating in an unlicensed spectrum, in accordance with certain aspects of the present disclosure.

FIG. 6 is an example direct frame number (DFN) cycle with latency between an over-the-air (OTA) subframe number and logical subframe number, in accordance with certain aspects of the present disclosure.

FIG. 7 is a flow diagram illustrating example operations for wireless communication, in accordance with certain aspects of the present disclosure.

FIG. 8 illustrates a communications device that may include various components configured to perform operations for the techniques disclosed herein in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for facilitating communications between wireless devices. For example, techniques described herein may relate to sidelink communication over a frequency band. In some examples, a wireless device (e.g., a cellular vehicle-to-everything (CV2X) device) is scheduled to communicate according to a subframe bitmap that indicates resources (e.g., subframes) available for sidelink communication. The wireless device may be semi-persistently scheduled (SPS) to repeat the subframe bitmap during a direct frame number (DFN) cycle. For example, the DFN cycle defines a DFN period that is equally divided into a number of index system frame numbers (SFNs). The SFNs are synchronized with subframe numbers throughout the DFN period. At the end of the DFN period, the SFN index is reset to 0. The DFN period may be longer than the subframe bitmap. For example, the DFN period may be up to 10240 subframes, while the subframe bitmap may be for 100 subframes or less. Thus, the subframe bitmap may define subframes that are available and not available for up to 100 subframes. The wireless device may follow the same pattern of available resources defined by the subframe bitmap for the next up to 100 subframes, and so on, until the end of the DFN period. Thus, in the example 10240 subframe DFN period and a 100 subframe length subframe bitmap, the wireless device may apply the configured subframe bitmap pattern 102 times for a 102 sets of one-hundred subframes. In some cases, subframes in the DFN cycle are reserved and cannot be used by the wireless device for sidelink communication. The subframes may be reserved for a sidelink synchronization signal (SLSS). The subframes may be reserved based on a size of the configured subframe bitmap. The reserved subframes may introduce end-to-end latency at the wireless device. For example, an upper layer (e.g., an application layer) at the wireless device schedules the wireless device based on an over-the-air (OTA) subframe number and the wireless device physical layer (e.g., modem) schedules the wireless device based on a logical subframe number. With each reserved subframe, a latency gap increases between when packets arrive at the upper layer and the actual OTA transmission of the packet.

According to aspects of the disclosure, the wireless device can trigger sidelink transmission resource reselection when the latency gap exceeds a threshold, or when the latency gap increases beyond a threshold. It should be noted that though certain aspects are described with respect to CV2X devices, it can be appreciated that the aspects may similarly be applicable to other scenarios, such as any communications (e.g., sidelink communications).

The following description provides examples of techniques for latency triggered resource reselection. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency band, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

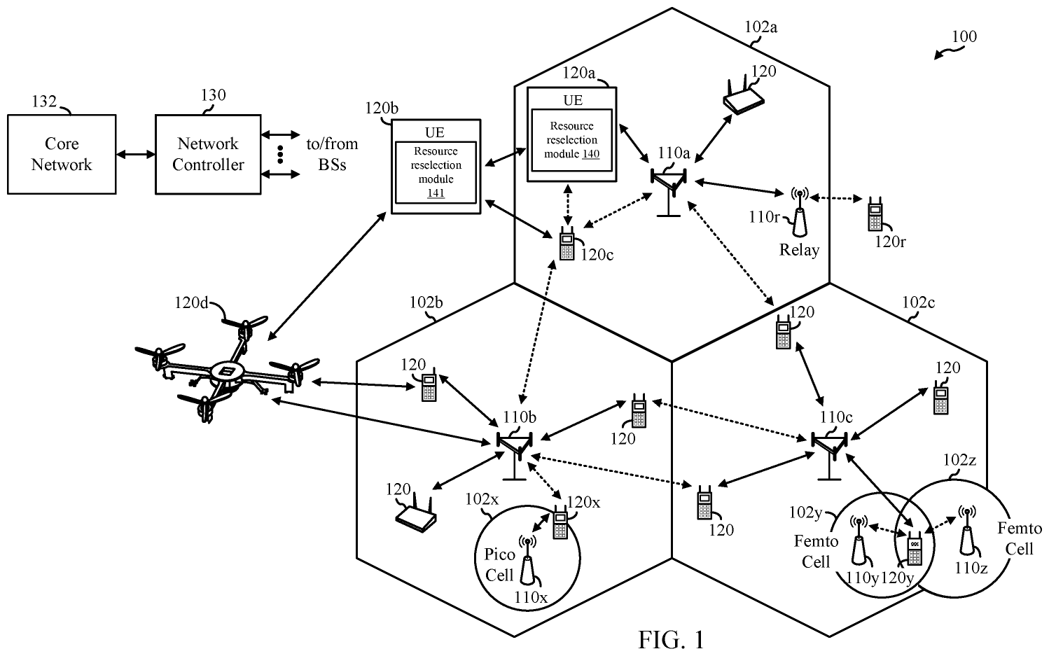

FIG. 1 illustrates an example wireless communication network 100 in which aspects of the present disclosure may be performed. For example, wireless communication network 100 may be an NR system (e.g., a 5G NR network). As shown in FIG. 1, wireless communication network 100 may be in communication with a core network 132. Core network 132 may be in communication with one or more base station (BSs) 110a-z (each also individually referred to herein as BS 110 or collectively as BSs 110), user equipment (UE) 120a-y (each also individually referred to herein as UE 120 or collectively as UEs 120), and/or other entities in the wireless communication network 100 via one or more interfaces.

ABS 110 may provide communication coverage for a particular geographic area, sometimes referred to as a “cell”, which may be stationary or may move according to the location of a mobile BS 110. In some examples, BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, BSs 110a, 110b and 110c may be macro BSs for the macro cells 102a, 102b and 102c, respectively. BS 110x may be a pico BS for pico cell 102x. BSs 110y and 110z may be femto BSs for femto cells 102y and 102z, respectively. A BS 110 may support one or multiple cells. A network controller 130 may couple to a set of BSs 110 and provide coordination and control for these BSs 110 (e.g., via a backhaul).

UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., BS 110a or UE 120r) and sends a transmission of the data and/or other information to a downstream station (e.g., UE 120 or BS 110), or that relays transmissions between UEs 120, to facilitate communication between devices.

In some examples of wireless communication network 100, UE 120a may initiate a sidelink communication with UE 120b without relying on a direct connection with a base station (e.g., base station 110a), such as if UE 120b is outside of cell 102a's range. Any of the UEs illustrated in FIG. 1 may function as a scheduling entity or a primary sidelink device, while the other UEs may function as a subordinate entity or a non-primary (e.g., secondary) sidelink device. Further, the UEs may be configured to transmit synchronization signaling for sidelink as described throughout the disclosure. Accordingly, one or more of the UEs may function as a scheduling entity in a device-to-device (D2D), peer-to-peer (P2P), or vehicle-to-vehicle (V2V) network, and/or in a mesh network to initiate and/or schedule synchronization signaling.

According to certain aspects, UEs 120 may be configured for sidelink resource reselection. As shown in FIG. 1, UE 120a includes a resource selection module 140 and UE 120b includes a resource reselection module 141. Resource reselection module 140 and/or resource reselection module 141 may be configured to trigger resource selection for sidelink transmission when a latency between at upper layer and physical layer at UE 120a and/or 120b exceeds a threshold latency.

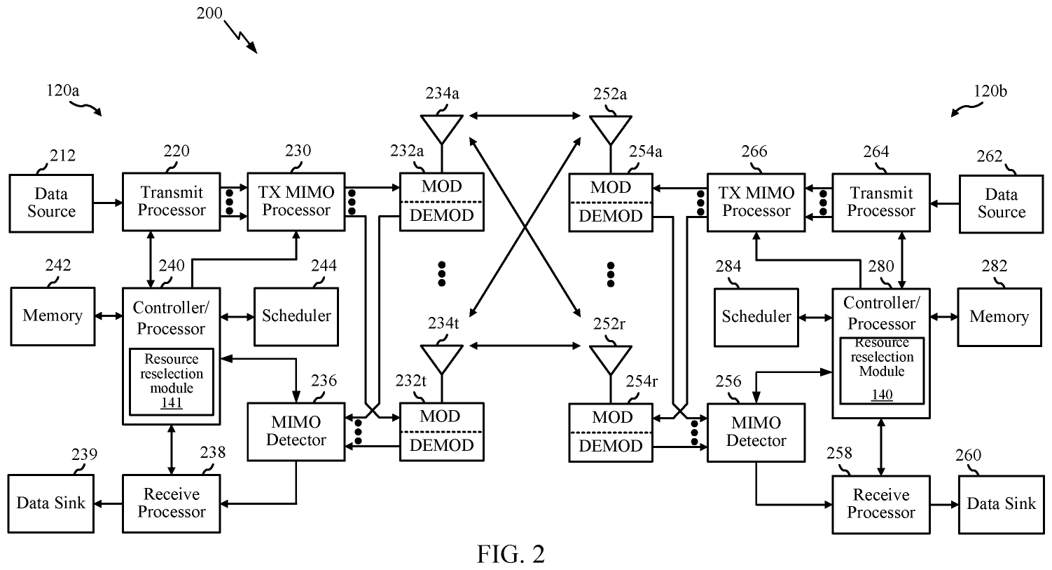

FIG. 2 illustrates example components 200 of a first UE 120a and a second UE 120b (e.g., in the wireless communication network 100 of FIG. 1), which may be used to implement aspects of the present disclosure.

At first UE 120a, a transmit processor 220 may receive data from a data source 212 and control information from a controller/processor 240. The control information may be for the physical broadcast channel (PBCH), physical sidelink broadcast channel (PSBCH), physical control format indicator channel (PCFICH), physical hybrid automatic repeat request (ARQ) indicator channel (PHICH), physical downlink control channel (PDCCH), group common PDCCH (GC PDCCH), etc. The data may be for the physical downlink shared channel (PDSCH), physical sidelink shared channel (PSSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator may process a respective output symbol stream (e.g., for OFDM, etc.) to obtain an output sample stream. Each modulator may further process (e.g., convert to analog, amplify, filter, and upconvert) the output sample stream to obtain a signal. Signals from modulators in transceivers 232a-232t may be transmitted via antennas 234a-234t, respectively.

At second UE 120b, antennas 252a-252r may receive signals from first UE 120a and may provide the received signals to the demodulators (DEMODs) in transceivers 254a-254r, respectively. Each demodulator may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data to a data sink 260, and provide decoded control information to a controller/processor 280.

Transmit processor 264 may receive and process data from a data source 262 and control information from controller/processor 280. Transmit processor 264 may also generate reference symbols for a reference signal (e.g., for the sounding reference signal (SRS)). The symbols from transmit processor 264 may be precoded by a TX MIMO processor 266 if applicable, further processed by modulators in transceivers 254a-254r and transmitted to first UE 120a. At first UE 120a, signals from second UE 120b may be received by the antennas 234, processed by modulators 232, detected by MIMO detector 236 if applicable, and further processed by receive processor 238 to obtain decoded data and control information sent by second UE 120b. Receive processor 238 may provide the decoded data to a data sink 239 and the decoded control information to controller/processor 240.

Memories 242 and 282 may store data and program codes for first UE 120a and second UE 120b, respectively. A scheduler 244/284 may schedule UEs 120a and 120b for data transmission/reception.

Antennas 252, processors 266, 258, 264, and/or controller/processor 280 of second UE 120b and/or antennas 234, processors 220, 230, 238, and/or controller/processor 240 of first UE 120a may be used to perform the various techniques and methods described herein. For example, as shown in FIG. 2, controller/processor 240 of first UE 120a includes resource reelection module 140 and controller/processor 280 of second UE 120b includes resource reselection module 141.

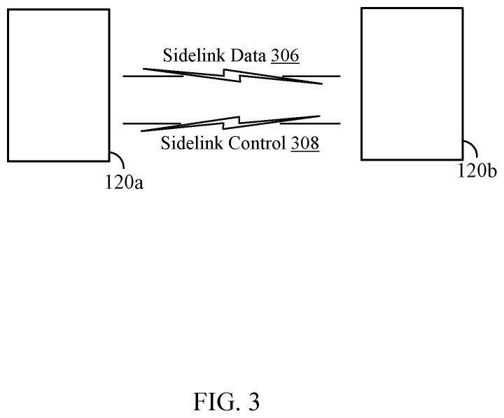

FIG. 3 is a diagram conceptually illustrating a sidelink communication between first UE 120a and second UE 120b.

In some examples, first UE 120a and the second UE 120b may utilize sidelink signals for direct D2D communication. The D2D communication may use the downlink/uplink wireless wide area network (WWAN) spectrum and/or an unlicensed spectrum. The D2D communication may use one or more sidelink channels, such as a PSBCH, a PSDCH, a PSSCH, and a PSCCH over these spectrums. D2D communication may be through a variety of wireless D2D communications systems, such as for example, FlashLinQ, WiMedia, Bluetooth, ZigBee, Wi-Fi based on the IEEE 802.11 standard, LTE, or NR.

Sidelink signals may include sidelink data 306 (i.e., sidelink traffic) and sidelink control information 308. Broadly, first UE 120a and one or more second UEs 120b may communicate sidelink data 306 and sidelink control information 308 using one or more data channels and control channels. In some aspects, data channels include the PSSCH, and control channels include the PSCCH and/or physical sidelink feedback channel (PSFCH).

Sidelink control information 308 may include a source transmit signal (STS), a direction selection signal (DSS), and a destination receive signal (DRS). The DSS/STS may provide for a UE 120 (e.g., 120a, 120b) to request a duration of time to keep a sidelink channel available for a sidelink signal. The DRS may provide for UE 120 to indicate the availability of the sidelink channel, e.g., for a requested duration of time. Accordingly, first UE 120a and second UE 120b may negotiate the availability and use of sidelink channel resources prior to communication of sidelink data 306 information.

In some configurations, any one or more of first UE 120a or second UE 120b may periodically/aperiodically transmit or broadcast sidelink synchronization signaling to increase chances of detection by another UE or BS. For example, one or more of first UE 120a and second UE 120b may periodically/aperiodically transmit sidelink synchronization signals in one or more slots of specific time windows. In some examples, the UEs are (e.g., pre-) configured with information indicating the location and duration of the time window within a frame (e.g., which slots within the frame, and how many). In some aspects, the UEs may be configured with the location and duration of the time window via messaging between UEs or messaging received from a BS (e.g., radio resource control (RRC) signaling).

NR may utilize orthogonal frequency division multiplexing (OFDM) with a cyclic prefix (CP). NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

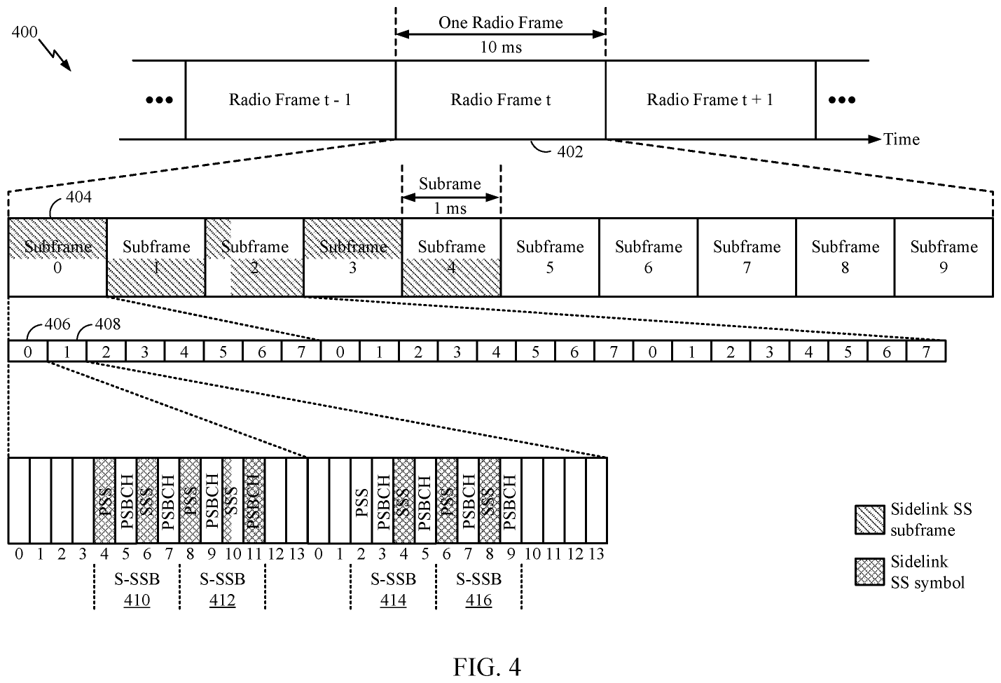

FIG. 4 is a diagram showing an example of a frame format 400. The transmission timeline for each data transmission and reception may be partitioned into units of radio frames 402. In NR, the basic transmission time interval (TTI) may be referred to as a slot. In NR, a subframe may contain a variable number of slots (e.g., 1, 2, 4, 8, 16, . . . , N slots) depending on the subcarrier spacing (SCS). NR may support a base SCS of 15 KHz and other SCS may be defined with respect to the base SCS (e.g., 30 kHz, 60 kHz, 120 kHz, 240 kHz, etc.). In the example shown in FIG. 4, the SCS is 120 kHz. As shown in FIG. 4, subframe 404 (subframe 0) contains 8 slots (slots 0, 1, . . . , 7 with a 0.125 ms duration. The symbol and slot lengths scale with the subcarrier spacing. Each slot may include a variable number of symbol (e.g., OFDM symbols) periods (e.g., 7 or 14 symbols) depending on the SCS. For the 120 kHz SCS shown in FIG. 4, each of the slot 406 (slot 0) and slot 408 (slot 1) includes 14 symbol periods (slots with indices 0, 1, . . . , 13) with a 0.25 ms duration.

In sidelink, a sidelink synchronization signal block (S-SSB), referred to as the SS block or SSB, is transmitted. The SSB may include a PSS, a SSS, and/or a two symbol PSBCH. In some examples, the SSB can be transmitted up to sixty-four times with up to sixty-four different beam directions. The up to sixty-four transmissions of the SSB are referred to as the SS burst set. SSBs in an SS burst set may be transmitted in the same frequency region, while SSBs in different SS bursts sets can be transmitted in different frequency regions.

In the example shown in FIG. 4, in subframe 404, SSB is transmitted in each of the slots (slots 0, 1, . . . , 7. In the example shown in FIG. 4, in slot 406 (slot 0), SSB 410 is transmitted in the symbols 4, 5, 6, 7 and SSB 412 is transmitted in the symbols 8, 9, 10, 11, and in the slot 408 (slot 1), SSB 414 is transmitted in the symbols 2, 3, 4, 5 and an SSB 416 is transmitted in the symbols 6, 7, 8, 9, and so on. PSS and SSS may be used by UEs to establish sidelink communication (e.g., transmission and/or reception of data and/or control channels). The PSS may provide half-frame timing, the SS may provide cyclic prefix (CP) length and frame timing. The PSBCH carries some basic system information, such as system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), and other system information (OSI) can be transmitted on a PSSCH in certain subframes.

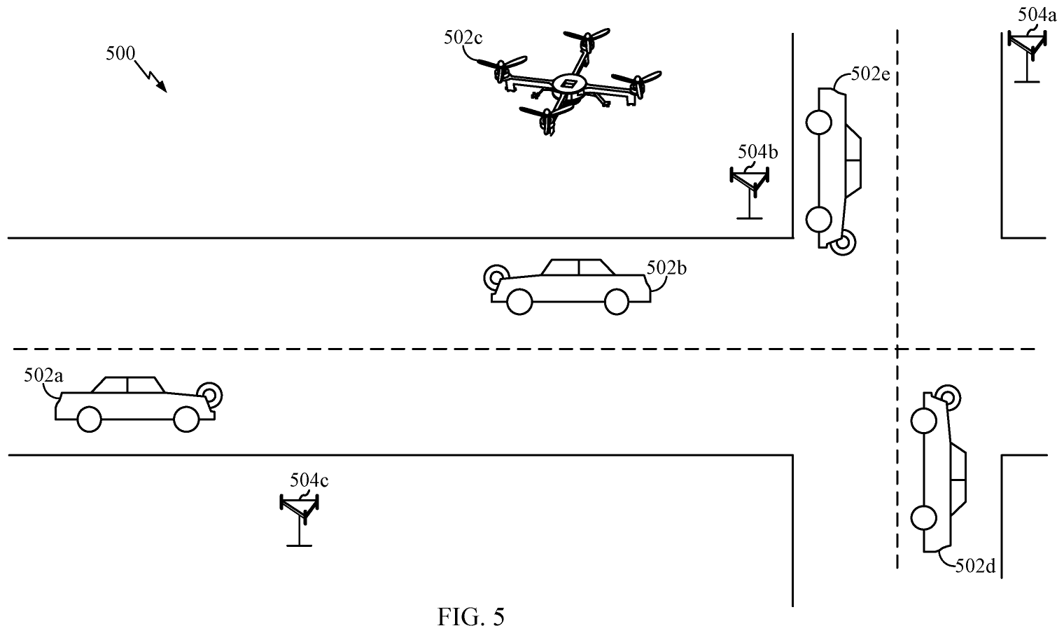

FIG. 5 is a schematic diagram illustrating an example network 500 of multiple CV2X devices operating in an unlicensed spectrum. In the illustrated example, five CV2X devices (e.g., a first CV2X device 502a, a second CV2X device 502b, a third CV2X device 502c, a fourth CV2X device 502d, and a fifth CV2X device 502e)—collectively referred to as CV2X devices 502) may operate with other non-CV2X devices (e.g., non-CV2X devices 504a-c—collectively referred to as non-CV2X devices 504). Although the example provided is illustrative of four automotive CV2X devices in a traffic setting and a drone CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

A C-V2X system may operate in various modes. An example mode, referred to as Mode 3, may be used when the UE is in a coverage area of a network. In the Mode 3, the network may control allocation of resources for the sidelink UEs. In another example mode for V2X systems, referred to as Mode 4, the sidelink UEs may autonomously select resources (e.g., resource blocks (RBs)) used for transmissions to communicate with each other. For example, resources may be semi-persistent scheduling (SPS) resources. SPS resources can be semi-statically configured, such as using radio resource control (RRC) signaling. The SPS resources may be activated and used for a specified period or until released. SPS resources can be used without need for a dynamic grant for each transmission as may be the case for dynamic scheduling. The SPS resource may be configured with a periodicity at which the SPS resource is used. In some examples, the sidelink UEs can autonomously select resources based on an SPS algorithm. The SPS algorithm may be configured, hardcoded, or preconfigured at the UE. For example, the SPS algorithm may be based on an SPS algorithm defined in the 3GPP technical standards. The SPS algorithm may involve performing channel sensing, excluding resources from resource selection based on the sensing, and randomly reselecting from non-excluded resources.

A sidelink device may be configured (or pre-configured) with a subframe bitmap. For example, 3GPP TS 36.331, Section 9.3.2 defines a parameter SL-V2X-PreconfigCommonPool-r14 with a parameter SubframeBitmapSL-r14. Subframe bitmaps of various size (e.g., bit string lengths) can be configured at the wireless device. Some example subframe bitmaps include a 10, 16, 20, 30, 40, 50, 60, or 100 bit string subframe bitmap. In some cases, this may correspond to a bitmap that can schedule sets of 10, 16, 20, 30, 40, 50, 60, or 100 subframes. A “0” in the bitmap may correspond to a subframe that is not scheduled for the wireless device and a “1” may correspond to a subframe that is scheduled for the wireless device to transmit a sidelink transmission.

In some systems (e.g., V2X sidelink communications), the network configures a 16 bit, 20, or 100 bit size subframe bitmap for frequency division duplexing (FDD) or a Frame Structure Type 1 (e.g., as defined in 3GPP TS 36.211). For TDD or Frame Structure Type 2 (e.g., as defined in 3GPP TS 36.211), the network may configure a 60 bit size subframe bitmap for configuration0, a 40 bit size subframe bitmap for configuration1, a 20 bit size subframe bitmap for configuration2, a 30 bit size subframe bitmap for configuration3, a 20 bit size subframe bitmap for configuration4, a 10 bit size subframe bitmap for configuration5, and a 50 bit size subframe bitmap for configuration6.

The wireless device may be SPS scheduled with the subframe bitmap. The wireless device may repeat the pattern of available subframes indicated by the subframe bitmap for multiple sets of subframes within a direct frame number (DFN) period of a DFN cycle, for example, based on the length of the DFN period and the length subframe bitmap. In CV2X systems, establishing time synchronization may include: (i) using global navigation satellite system (GNSS) as a common time reference (e.g., current coordinated universal time (UTC)), Tcurrent (e.g., in ms), from which a UE derives frame and slot boundaries; and (ii) using an in-band signaling method, with synchronization signals (e.g., beacon signals) broadcasted by devices. DFN may start at the beginning of GNSS time. For example, the DFN, or system frame number is the index of system frame modulo 1024 and can be given by Floor (0.1*Tcurrent) mod 1024. The subframe may be equal to mod (Tcurrent, 10). Thus, the DFN period (or DFN cycle) may be 1024 SFN. Scheduling is based on subframe number, thus, the DFN period is 1024*10=10240, which can be numbered 0 . . . 10239.

Upper layers at a wireless device, such as the application layer, schedule transmissions by the wireless device based on an over-the-air (OTA) subframe number. The physical layer at the wireless device (e.g., the modem) schedules the transmissions based on a logical subframe number. However, the logical SFN may drift with respect to the OTA SFN over time. For example, there may be an initial latency between a time at which packets arrive at the physical layer from the upper layer and the time of the actual OTA transmission of the packets. In addition, the latency between the packet arrival time and the OTA transmission increases when subframes are reserved throughout the DFN period.

Packets may be reserved based on the configured subframe bitmap. For example, a number of subframes corresponding to a remainder of the subframes in the DFN period divided by the configured subframe bitmap size may be reserved, according to #Reserved=DFN period % SFbitmap size. In an illustrative example, for the 100 bit size subframe bitmap, 40 subframes may be reserved because 10240%100=40. The reserved subframes are not available for scheduling. The reserved subframes may be equally distributed in the DFN period. Thus, in the illustrated example, one subframe is reserved every 256 subframes (10240/40=256).

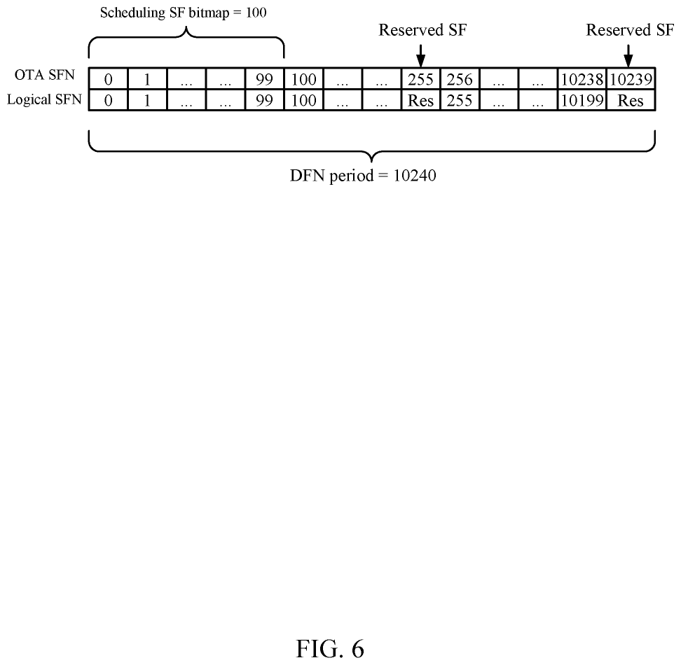

The subframes may be reserved at the physical layer, which schedules based on the logical number, but not at the upper layer which schedules based on the OTA number. Thus, the physical layer does not increment the logical subframe number for the reserved subframes and the upper layer increments the OTA subframe number for each reserved subframe. As shown in FIG. 6, in the illustrated example, the gap between OTA number and the logical number increases by one every 256 and, therefore, the end-to-end latency increases by 1 ms every 256 subframes as latency between the packet arrival time from upper layers and the actual OTA transmission increases. The number of reserved subframes and the gap further increases with subframes that are reserved for SLSS.

Thus, a procedure for deploying CV2X operations is desirable.

### Example Latency Triggered Resource Reselection

According to certain aspects, a wireless device triggers a resource selection (e.g., a resource reselection) when a latency between a packet arrival time from upper layers and an actual over-the-air (OTA) transmission time exceeds a latency threshold. In some examples, the resource selection is triggered when an initial latency increases beyond a threshold amount.

An initial time gap, X, may be determined between the upper layer and OTA transmission packet. The initial time gap may be the difference between a measured packet arrival time from an application layer and the OTA packet transmission time by the modem. The time gap may be a gap between a logical subframe number and an OTA subframe. The initial gap may be determined when a semi-persistent scheduling (SPS) flow is created. For example, when an SPS resource is activated for a wireless device, the initial gap can be determined for the packet sent using the activated SPS resource. For each reserved subframe during the DFN period, the time gap X will increase during the SPS flow transmission. The wireless device monitors the time gap and when the time gap increased by a threshold amount Y, or reaches a threshold size, X+Y, the wireless device triggers a sidelink resource reselection of resources that can be used for sidelink transmission by the wireless device. Y may correspond a maximum number of allowed reserved subframes. The value of Y may be configurable. The threshold (e.g., Y) can be randomized among wireless device. This may avoid a reselection storm, in which many wireless devices perform resource reselection at the same time.

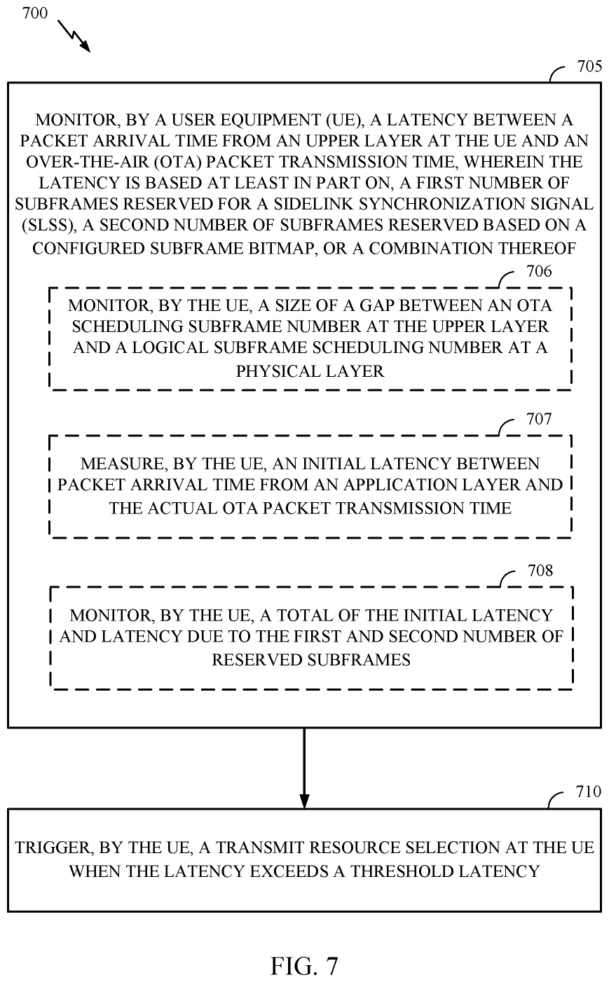

FIG. 7 is a flow diagram illustrating example operations 700 for wireless communication, in accordance with certain aspects of the present disclosure. The operations 700 may be performed, for example, by a UE (e.g., such as UE 120a or UE 120b in the wireless communication network 100 of FIG. 1). Operations 700 may be implemented as software components that are executed and run on one or more processors (e.g., controller/processor 240/280 of FIG. 2). Further, the transmission and reception of signals in operations 700 may be enabled, for example, by one or more antennas (e.g., antennas 234/252 of FIG. 2). In certain aspects, the transmission and/or reception of signals may be implemented via a bus interface of one or more processors (e.g., controller/processor 240/280) obtaining and/or outputting signals.

The operations 700 may begin, at block 705, by monitoring a latency between a packet arrival time from an upper layer at the UE and an OTA packet transmission time. The latency is based at least in part on, a first number of subframes reserved for a sidelink synchronization signal (SLSS), a second number of subframes reserved based on a configured subframe bitmap, or a combination thereof (e.g., based on both the first and second number of reserved subframes). The first and second number of subframes are reserved in a DFN period. The second number of subframes corresponds to a remainder of the DFN period divided by a length of the subframe bitmap. The reserved subframes are not available for transmission by the UE. The size of the gap increases at each reserved subframe.

Monitoring the latency may include, at 706, monitoring a size of a gap between an OTA scheduling subframe number at the upper layer and a logical subframe scheduling number at a physical layer. Monitoring the latency may include, at 707, measuring an initial latency between packet arrival time from an application layer and the actual OTA packet transmission time and, at 708, monitoring a total of the initial latency and latency due to the first and second number of reserved subframes

At block 710, the UE triggers a transmit resource selection (e.g., a reselection) at the UE when the latency exceeds a threshold latency. The threshold latency may be configurable. The threshold latency may be randomized among a plurality of UEs.

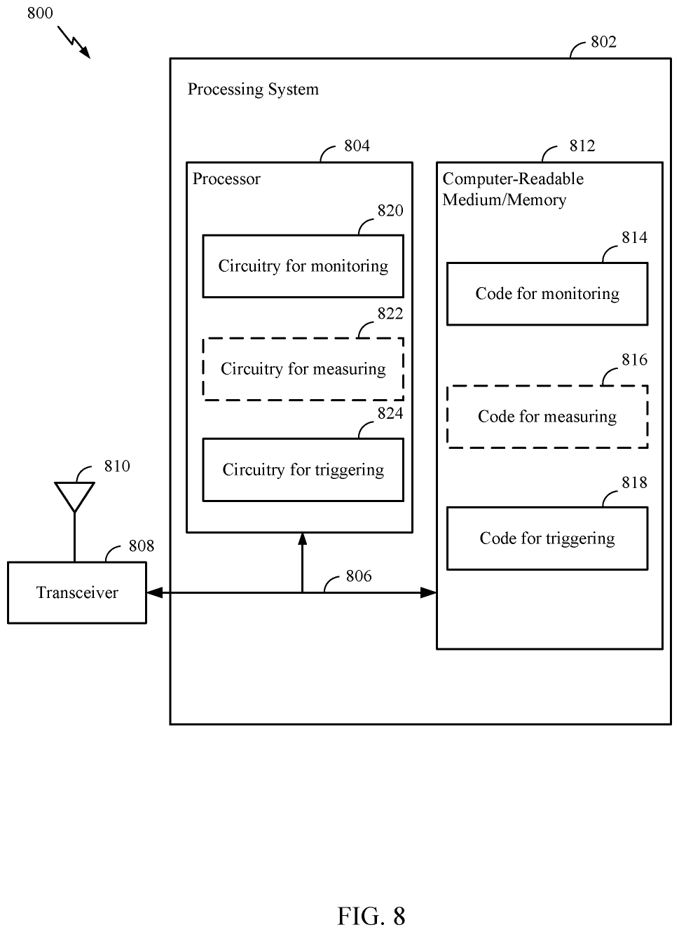

FIG. 8 illustrates a communications device 800 that may include various components (e.g., corresponding to means-plus-function components) configured to perform operations for the techniques disclosed herein, such as the operations illustrated in FIG. 7. Communications device 800 includes a processing system 802 coupled to a transceiver 808 (e.g., a transmitter and/or a receiver). Transceiver 808 is configured to transmit and receive signals for communications device 800 via an antenna 810, such as the various signals as described herein. Processing system 802 may be configured to perform processing functions for communications device 800, including processing signals received and/or to be transmitted by communications device 800.

Processing system 802 includes a processor 804 coupled to a computer-readable medium/memory 812 via a bus 806. In certain aspects, computer-readable medium/memory 812 is configured to store instructions (e.g., computer-executable code) that when executed by processor 804, cause processor 804 to perform the operations illustrated in FIG. 7, or other operations for performing the various techniques discussed herein for latency triggered resource reselection. Computer-readable medium/memory 812 stores code 814 for monitoring. Code 814 may include code for monitoring a latency between a packet arrival time from an upper layer at the UE and an OTA packet transmission time, wherein the latency is based at least in part on, a first number of subframes reserved for a SLSS, a second number of subframes reserved based on a configured subframe bitmap, or a combination thereof. Computer-readable medium/memory 812 stores code 818 for triggering. Code 818 for triggering may include code for triggering a transmit resource selection at the UE when the latency exceeds a threshold latency. Optionally, computer-readable medium/memory 812 stores code 816 for measuring. Code 816 may include code for measuring an initial latency between packet arrival time from an application layer and the actual OTA packet transmission time.

In certain aspects, the processor 804 has circuitry configured to implement the code stored in the computer-readable medium/memory 812. The processor 804 includes circuitry 820 for monitoring. Circuitry 822 may include circuitry for monitoring a latency between a packet arrival time from an upper layer at the UE and an OTA packet transmission time, wherein the latency is based at least in part on, a first number of subframes reserved for a SLSS, a second number of subframes reserved based on a configured subframe bitmap, or a combination thereof. Processor 804 includes circuitry 824 for triggering. Circuitry 824 for trigger may include circuitry for triggering a transmit resource selection at the UE when the latency exceeds a threshold latency. Optionally, processor 804 include circuitry 822 for measuring. Circuitry 822 for measuring may include circuitry for measuring an initial latency between packet arrival time from an application layer and the actual OTA packet transmission time.

### Example Aspects

In addition to the various aspects described above, the aspects can be combined. Some specific combinations of aspects are detailed below:

Aspect 1. A method of wireless communication by a user equipment (UE), comprising: monitoring a latency between a packet arrival time from an upper layer at the UE and an over-the-air (OTA) packet transmission time, wherein the latency is based at least in part on, a first number of subframes reserved for a sidelink synchronization signal (SLSS), a second number of subframes reserved based on a configured subframe bitmap, or a combination thereof; and triggering a transmit resource selection at the UE when the latency exceeds a threshold latency.

Aspect 2. The method of aspect 1, wherein monitoring the latency comprises monitoring a size of a gap between an OTA scheduling subframe number at the upper layer and a logical subframe scheduling number at a physical layer.

Aspect 3. The method of aspect 2, wherein the first and second number of subframes are reserved in a direct frame number (DFN) period, wherein the reserved subframes are not available for transmission by the UE, and wherein the size of the gap increases at each reserved subframe.

Aspect 4. The method of any of aspects 2-3, wherein the physical layer does not increment the logical subframe number for the reserved subframes and the upper layer increments the OTA subframe number for each reserved subframe.

Aspect 5. The method of claim of any of aspects 3-4, wherein the second number of subframes corresponds to a remainder of the DFN period divided by a length of the subframe bitmap.

Aspect 6. The method of aspect 5, wherein the DFN period comprises 1024 system frame numbers (SFNs) corresponding to 10,240 subframes, wherein the length of the subframe bitmap is 10, 16, 20, 30, 40, 50, 60, or 100 subframes, and wherein the subframe bitmap is repeated within the DFN period.

Aspect 7. The method of any of aspects 5-6, wherein the second number of subframes are reserved at a constant periodicity within the DFN period.

Aspect 8. The method of any of aspects 1-7, further comprising measuring an initial latency between packet arrival time from an application layer and the actual OTA packet transmission time, wherein monitoring the latency includes monitoring a total of the initial latency and latency due to the first and second number of reserved subframes.

Aspect 9. The method of any of aspects 1-8, wherein the threshold latency is configurable.

Aspect 10. The method of any of aspects 1-9, wherein the threshold latency is randomized among a plurality of UEs.

Aspect 11. An apparatus comprising means for performing the method of any of aspects 1 through 10.

Aspect 12. An apparatus comprising at least one processor and a memory coupled to the at least one processor, the memory comprising code executable by the at least one processor to cause the apparatus to perform the method of any of aspects 1 through 10.

Aspect 13. A computer readable medium storing computer executable code thereon for wireless communications that, when executed by at least one processor, cause an apparatus to perform the method of any of aspects 1 through 13.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. CdMA2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UNITS that use E-UTRA. UTRA, E-UTRA, UMTS, LIE, LTE-A and GSM are described in documents from an organization named “3rd Generation Partnership Project” (3GPP). CDMA2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

Within the present document, the term “user equipment (UE)” or “CV2X device” broadly refers to a diverse array of devices and technologies. UEs and CV2X devices may include a number of hardware structural components sized, shaped, and arranged to help in communication; such components can include antennas, antenna arrays, radio frequency (RF) chains, amplifiers, one or more processors, etc. electrically coupled to each other. For example, some non-limiting examples of a UE or CV2X device include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A UE or CV2X device may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A UE or CV2X device may additionally be a digital home or smart home device such as a home audio, video, and/or multimedia device, an appliance, a vending machine, intelligent lighting, a home security system, a smart meter, etc. A UE or CV2X device may additionally be a smart energy device, a security device, a solar panel or solar array, a municipal infrastructure device (e.g., a smart grid, public WiFi, etc.), an industrial automation and enterprise device, a logistics controller, agricultural equipment, military defense equipment: vehicles, aircraft, ships, and weaponry, etc. Still further, a UE or CV2X device may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U. S. C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise a non-transitory computer-readable medium (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 7.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communication, comprising:
at least one processor; and
a memory coupled to the at least one processor, the memory comprising code executable by the at least one processor to cause the apparatus to:
monitor a latency between a packet arrival time from an upper layer at the apparatus and an over-the-air (OTA) packet transmission time, wherein the latency is based at least in part on, a first number of subframes reserved for a sidelink synchronization signal (SLSS), a second number of subframes reserved based on a configured subframe bitmap, or a combination thereof; and
trigger a transmit resource selection at the apparatus when the latency exceeds a threshold latency.

2. The apparatus of claim 1, wherein the code executable by the at least one processor to cause the apparatus to monitor the latency comprises code executable by the at least one processor to cause the apparatus to monitor a size of a gap between an OTA scheduling subframe number at the upper layer and a logical subframe scheduling number at a physical layer.

3. The apparatus of claim 2, wherein the first and second number of subframes are reserved in a direct frame number (DFN) period, wherein the reserved subframes are not available for transmission by the apparatus, and wherein the size of the gap increases at each reserved subframe.

4. The apparatus of claim 2, wherein the physical layer does not increment the logical subframe number for the reserved subframes and the upper layer increments the OTA subframe number for each reserved subframe.

5. The apparatus of claim 3, wherein the second number of subframes corresponds to a remainder of the DFN period divided by a length of the subframe bitmap.

6. The apparatus of claim 5, wherein the DFN period comprises 1024 system frame numbers (SFNs) corresponding to 10,240 subframes, wherein the length of the subframe bitmap is 10, 16, 20, 30, 40, 50, 60, or 100 subframes, and wherein the subframe bitmap is repeated within the DFN period.

7. The apparatus of claim 5, wherein the second number of subframes are reserved at a constant periodicity within the DFN period.

8. The apparatus of claim 1, wherein the memory further comprises code executable by the at least one processor to cause the apparatus to measure an initial latency between packet arrival time from an application layer and the actual OTA packet transmission time, wherein the code executable by the at least one processor to cause the apparatus to monitor the latency comprises code executable by the at least one processor to cause the apparatus to monitor a total of the initial latency and latency due to the first and second number of reserved subframes.

9. The apparatus of claim 1, wherein the threshold latency is configurable.

10. The apparatus of claim 1, wherein the threshold latency is randomized among a plurality of apparatuses.

11. A method of wireless communication by a user equipment (UE), comprising:
monitoring a latency between a packet arrival time from an upper layer at the UE and an over-the-air (OTA) packet transmission time, wherein the latency is based at least in part on, a first number of subframes reserved for a sidelink synchronization signal (SLSS), a second number of subframes reserved based on a configured subframe bitmap, or a combination thereof; and
triggering a transmit resource selection at the UE when the latency exceeds a threshold latency.

12. The method of claim 11, wherein monitoring the latency comprises monitoring a size of a gap between an OTA scheduling subframe number at the upper layer and a logical subframe scheduling number at a physical layer.

13. The method of claim 12, wherein the first and second number of subframes are reserved in a direct frame number (DFN) period, wherein the reserved subframes are not available for transmission by the UE, and wherein the size of the gap increases at each reserved subframe.

14. The method of claim 12, wherein the physical layer does not increment the logical subframe number for the reserved subframes and the upper layer increments the OTA subframe number for each reserved subframe.

15. The method of claim 13, wherein the second number of subframes corresponds to a remainder of the DFN period divided by a length of the subframe bitmap.

16. The method of claim 15, wherein the DFN period comprises 1024 system frame numbers (SFNs) corresponding to 10,240 subframes, wherein the length of the subframe bitmap is 10, 16, 20, 30, 40, 50, 60, or 100 subframes, and wherein the subframe bitmap is repeated within the DFN period.

17. The method of claim 15, wherein the second number of subframes are reserved at a constant periodicity within the DFN period.

18. The method of claim 11, further comprising measuring an initial latency between packet arrival time from an application layer and the actual OTA packet transmission time, wherein monitoring the latency includes monitoring a total of the initial latency and latency due to the first and second number of reserved subframes.

19. The method of claim 11, wherein the threshold latency is configurable.

20. The method of claim 11, wherein the threshold latency is randomized among a plurality of UEs.

21. An apparatus for wireless communication, comprising:
means for monitoring a latency between a packet arrival time from an upper layer at the apparatus and an over-the-air (OTA) packet transmission time, wherein the latency is based at least in part on, a first number of subframes reserved for a sidelink synchronization signal (SLSS), a second number of subframes reserved based on a configured subframe bitmap, or a combination thereof; and
means for triggering a transmit resource selection at the apparatus when the latency exceeds a threshold latency.

22. The apparatus of claim 21, wherein means for monitoring the latency comprises means for monitoring a size of a gap between an OTA scheduling subframe number at the upper layer and a logical subframe scheduling number at a physical layer.

23. The apparatus of claim 22, wherein the first and second number of subframes are reserved in a direct frame number (DFN) period, wherein the reserved subframes are not available for transmission by the UE, and wherein the size of the gap increases at each reserved subframe.

24. The apparatus of claim 22, wherein the physical layer does not increment the logical subframe number for the reserved subframes and the upper layer increments the OTA subframe number for each reserved subframe.

25. The apparatus of claim 23, wherein the second number of subframes corresponds to a remainder of the DFN period divided by a length of the subframe bitmap.

26. The apparatus of claim 25, wherein the DFN period comprises 1024 system frame numbers (SFNs) corresponding to 10,240 subframes, wherein the length of the subframe bitmap is 10, 16, 20, 30, 40, 50, 60, or 100 subframes, and wherein the subframe bitmap is repeated within the DFN period.

27. The apparatus of claim 25, wherein the second number of subframes are reserved at a constant periodicity within the DFN period.

28. The apparatus of claim 21, further comprising means for measuring an initial latency between packet arrival time from an application layer and the actual OTA packet transmission time, wherein means for monitoring the latency includes means for monitoring a total of the initial latency and latency due to the first and second number of reserved subframes.

29. The apparatus of claim 21, wherein the threshold latency is configurable.

30. A computer readable medium storing computer executable code thereon for wireless communication by a user equipment (UE), comprising:
code for monitoring a latency between a packet arrival time from an upper layer at the UE and an over-the-air (OTA) packet transmission time, wherein the latency is based at least in part on, a first number of subframes reserved for a sidelink synchronization signal (SLSS), a second number of subframes reserved based on a configured subframe bitmap, or a combination thereof; and
code for triggering a transmit resource selection at the UE when the latency exceeds a threshold latency.
